(19) United States
(12) Patent Application Publication
(10) Pub. No.: US 2008/0180579 A1
(43) Pub. Date: Jul. 31, 2008

(54) Techniques for Improving Harmonic and Image Rejection Performance of an RF Receiver Mixing DAC

(75) Inventor: Adrian Maxim, Austin, TX (US)

Correspondence Address: LARSON NEWMAN ABEL POLANSKY & WHITE, LLP, 5914 WEST COURTYARD DRIVE, SUITE 200, AUSTIN, TX, 78730, US

(73) Assignee: SILICON LABORATORIES, INC., Austin, TX (US)

(21) Appl. No.: 11/669,773

(22) Filed: Jan. 31, 2007

(51) Int. Cl. H04N 5/44; H04L 27/06

(52) U.S. Cl. 348/735; 375/340; 348/E05.108

(57) ABSTRACT

A receiver (400) includes a mixing digital-to-analog converter (DAC) (410), a direct digital frequency synthesizer (DDFS) (402), a scrambler (404), a decoder (406), and a multiplexer (408). The DDFS (402) includes outputs configured to provide bits associated with a digital local oscillator (LO) signal to control inputs of the mixing DAC (410). The scrambler (404) includes inputs coupled to the outputs of the DDFS (402) and is configured to scramble the bits of the digital LO signal. The decoder (406) includes inputs coupled to the outputs of the DDFS (402). The decoder (406) is configured to provide the bits of the digital LO signal without scrambling. The multiplexer (408) includes first inputs coupled to outputs of the scrambler (404), second inputs coupled to outputs of the decoder (406), and outputs coupled to the control inputs of the DDFS (402). The multiplexer (408) is configured to couple the first inputs to the control inputs of the mixing DAC (410) for a first frequency band and to couple the second inputs to the control inputs of the mixing DAC (410) for a second frequency band.

### FIELD OF THE DISCLOSURE

The present disclosure is generally directed to a radio frequency (RF) receiver and, more particularly, to techniques for improving harmonic and image rejection performance of an RF receiver mixing digital-to-analog converter (DAC).

### BACKGROUND

Designing a broadband radio frequency (RF) receiver to meet a desired harmonic and image rejection performance can be a challenging task. As is well known, an RF receiver is tuned to a desired channel by changing a frequency (f_{LO}) of a local oscillator (LO) of the RF receiver. Unfortunately, several undesired channels (i.e., blockers) may exist at frequencies that may be down-converted by harmonics, e.g., 2f_{LO}, 3f_{LO}, etc., of the LO frequency. Furthermore, a large blocker may exist at an image frequency (f_{image}) of a desired frequency (f_{desired}) which may be down-converted onto a desired channel, i.e., f_{image}=f_{LO}+f_{IF} and f_{desired}=f_{LO}−f_{IF} for high-side mixing. The harmonic issue in television (TV) receivers (tuners) is exacerbated by the relatively wide frequency range (e.g., about 40 MHz to 860 MHz) of the TV spectrum. Moreover, the harmonic issue is further exacerbated in the digital TV (DTV) spectrum, as the DTV spectrum is more densely populated than the analog TV spectrum.

One technique for addressing the harmonic issue in discrete TV tuners has implemented separate receive paths for very high frequency (VHF)-low, VHF-high, and ultra high frequency (UHF) TV bands, respectively. A relevant portion of a prior art RF receiver 200 that employed this technique is illustrated in FIG. 2. The receiver 200 includes an antenna 228 that is coupled to an input of a switch 226, whose outputs are coupled to respective inputs of a VHF-low filter 220, a VHF-high filter 222, and a UHF filter 224. An output of the filter 220 is coupled to an input of a low-noise amplifier (LNA) 206, whose output is coupled to an input of a mixer 212. An output of the mixer 212 is coupled to an input of an amplifier 218. An output of the filter 222 is coupled to an input of LNA 208, whose output is coupled to an input of a mixer 214, whose output is coupled to the input of the amplifier 218. An output of the filter 224 is coupled to an input of LNA 210, whose output is coupled to an input of a mixer 216. An output of the mixer 216 is coupled to the input of the amplifier 218. The mixers 212, 214, and 216 receive appropriate local oscillator (LO) signals, based on a desired channel, from a LO frequency synthesizer 230. While initial channel allocation generally avoids 2LO harmonic issues, the filters 220, 222, and 224 have usually been required to track a desired channel to adequately address 3LO, 4LO, and 5LO harmonic mixing and image mixing issues. That is, the filters 220, 222, and 224 have usually been tuned based on the desired channel frequency to achieve relatively high rejection of undesired channels. Unfortunately, tracking filters tend to be relatively complex and difficult to fully implement within an integrated circuit (IC).

The integration of a TV tuner in a single IC has been facilitated using an up-down dual conversion architecture. With reference to FIG. 3, an RF receiver 300 is depicted that implements an up-down dual conversion architecture. The receiver 300 includes an antenna 302 that is coupled to an input of a TV band selection filter 304, whose output is coupled to an input of a low noise amplifier (LNA) 306. An output of the LNA 306 is coupled to a first input of a mixer 308, A second input of the mixer 308 receives a local oscillator (LO) signal from an LO synthesizer 318. An output of the mixer 308 provides an up-converted signal (e.g., in the range of 1.1 to 1.7 GHz) to an input of an off-chip surface acoustic wave (SAW) filter 310. An output of the SAW filter 310 is coupled to an input of an on-chip amplifier 312, whose output is coupled to a first input of a mixer 320. A second input of the mixer 320 receives an LO signal from LO synthesizer 314. An output of the mixer 320 provides a down-converted signal (e.g., in the range of 33 to 60 MHz) to an input of an intermediate frequency (IF) amplifier 316.

In sum, in RF receivers employing this architecture, a desired channel is first up-converted to a relatively high frequency, e.g., between about 1.1 GHz to 1.7 GHz. The up-conversion of the channel moves the image frequency to a very high frequency, where no strong blocker exists. In this architecture, the front-end TV band select filter 304 has been implemented to filter out-of-band blockers. Furthermore, in this architecture, higher-order harmonics are at very high frequencies that are out-of-band, where no blockers exist. The up-converted signal has been filtered with an off-chip surface acoustic wave (SAW) filter and the filtered up-converted signal has then been down-converted to a standard TV intermediate frequency (IF) signal. While the architecture addresses image and LO harmonic mixing issues for broadband terrestrial/cable TV tuners, the architecture has a relatively high power dissipation, due to the off-chip SAW filter and the relatively high frequency stages. Moreover, such architectures tend to be relatively expensive due to the off-chip SAW filter.

What is needed is a relatively inexpensive radio frequency receiver that provides relatively good harmonic and image rejection performance.

### SUMMARY

According to one embodiment, a receiver includes a mixing digital-to-analog converter (DAC), a direct digital frequency synthesizer (DDFS), a scrambler, a decoder, and a multiplexer. The mixing DAC includes a radio frequency (RF) input configured to receive an RF signal, control inputs configured to receive bits associated with a digital local oscillator (LO) signal, and an output. The mixing DAC is configured to mix the RF signal with the digital LO signal to provide an analog output signal at the output of the mixing DAC. The DDFS includes outputs configured to provide the bits associated with the digital LO signal. The scrambler includes inputs coupled to the outputs of the DDFS and is configured to scramble the bits of the digital LO signal. The decoder includes inputs coupled to the outputs of the DDFS and is configured to provide the bits of the digital LO signal without scrambling. The multiplexer includes first inputs coupled to outputs of the scrambler, second inputs coupled to outputs of the decoder, and outputs coupled to the control inputs of the mixing DAC. The multiplexer is configured to couple the first inputs to the control inputs of the mixing DAC for a first frequency band and to couple the second inputs to the control inputs of the mixing DAC for a second frequency band.

According to another embodiment, a receiver includes a mixing digital-to-analog converter (DAC), a direct digital frequency synthesizer (DDFS), and a synchronization circuit. The mixing DAC includes a radio frequency (RF) input configured to receive an RF signal, control inputs configured to receive bits associated with a digital local oscillator (LO) signal, and an output. The mixing DAC is configured to convert the RF signal to an RF current signal and mix the RF current signal with the digital LO signal to provide an analog output signal at the output of the mixing DAC. The DDFS includes outputs configured to provide the bits associated with the digital LO signal. The synchronization circuit is coupled between the outputs of the DDFS and the control inputs of the mixing DAC and includes a clock H-tree for distributing a clock signal to latches of the synchronization circuit.

According to yet another embodiment, a receiver includes a complex mixing digital to-analog converter (DAC) and a direct digital frequency synthesizer (DDFS). The complex mixing DAC includes an in-phase radio frequency (RF) transconductance section, a quadrature RF transconductance section, and a switching matrix. The in-phase RF transconductance section includes an input configured to receive an RF signal and an output configured to provide an in-phase RF current signal. The quadrature RF transconductance section includes an input configured to receive the RF signal and an output configured to provide a quadrature RF current signal. The switching matrix includes in-phase (I) cells coupled to the in-phase RF transconductance section and quadrature (Q) cells coupled to the quadrature RF transconductance section.

Each of the I and Q cells includes a synchronization circuit having an input configured to receive a bit associated with either an in-phase digital local oscillator (LO) or a quadrature digital LO signal and a switching section having a control input coupled to an output of the synchronization circuit. The synchronization circuit in each of the I and Q cells is configured to be clocked by a common clock signal to synchronize the bits associated with the in-phase and quadrature digital LO signals at the control input of the switching section in each of the I and Q cells. The DDFS includes outputs configured to provide the bits associated with the in-phase and quadrature digital LO signals. The I and Q cells are arranged to substantially cancel linear gradients along horizontal and vertical axes of the switching matrix when the receiver is operational. It should be appreciated that an arbitrary linear gradient can be expressed as a combination of gradients along horizontal and vertical axes.

According to another embodiment, a technique of reducing switching noise associated with a thermometer encoded digital-to-analog converter (DAC) section of a mixing DAC includes receiving a radio frequency (RF) signal at an input of an RE transconductance section of the mixing DAC. The RF transconductance section converts the RF signal into an RF current signal, which is mixed with a digital local oscillator (LO) signal using a switching matrix that is coupled to the RF transconductance section. The switching matrix is divided into multiple cells each of which includes a synchronization circuit and a switching section. The synchronization circuit includes an input configured to receive a bit of the digital LO signal, which includes multiple bits. The switching section includes an input coupled to an output of the synchronization circuit. The synchronization circuit in each of the cells is configured to be clocked by a common clock signal to synchronize the multiple bits associated with the digital LO signal at a control input of the switching section in each of the cells.

According to another embodiment, a technique of reducing switching in a thermometer encoded digital-to-analog converter (DAC) section that includes switching matrix cells is disclosed. The thermometer encoded DAC section is included within a mixing digital-to-analog converter (DAC) of a receiver. The technique includes determining first active bits for a digital local oscillator (LO) signal in a current state. The first active bits are each associated with respective first cells included within the switching matrix cells and the digital LO signal is provided to control inputs of the mixing DAC. Second active bits are determined for the digital LO signal for a next state. The second active bits are each associated with respective second cells included within the switching matrix cells. Noise induced switching in the mixing DAC is reduced by ensuring that at least one of the first cells is included within the second cells.

### BRIEF DESCRIPTION OF THE DRAWINGS

The present disclosure may be better understood, and its numerous features and advantages made apparent to those skilled in the art by referencing the accompanying drawings, in which:

FIG. 1 is an electrical diagram, in block and schematic form, of a relevant portion of a radio frequency (RF) receiver that implements a mixing digital-to-analog converter (DAC), configured according to an embodiment of the present invention;

FIG. 2. is an electrical block diagram of a relevant portion of an RF receiver that employs a switch to select one of plurality of filters and an associated low-noise amplifier (LNA) and mixer, according to the prior art;

FIG. 3 is an electrical block diagram of a relevant portion of an RF receiver that implements a dual conversion (up-down) architecture, according to the prior art;

FIG. 4 is an electrical block diagram of a relevant portion of an RF receiver that implements a direct digital frequency synthesizer (DDFS) driven mixing DAC, configured according to an embodiment of the present invention;

FIG. 5 is an electrical block diagram of a relevant portion of an RF receiver that implements a DDFS driven mixing DAC, configured according to another embodiment of the present invention;

FIG. 6 is an electrical block diagram of a relevant portion of an RF receiver that implements a DDFS driven mixing DAC, configured according to an aspect of the present invention;

FIG. 7 is an electrical block diagram of a clock tree for driving a synchronization circuit provided between a DDFS and a mixing DAC;

FIG. 8 is an electrical diagram, in block and layout form, of a clock H-tree for driving a synchronization circuit provided between a DDFS and a mixing DAC, according to another aspect of the present invention;

FIG. 9 is an electrical diagram, in block and layout form, of a clock H-tree for driving a synchronization circuit provided between a DDFS and a mixing DAC and an output current H-tree for the mixing DAC, according to an embodiment of the present invention;

FIG. 10 is a layout diagram for arranging in-phase and quadrature mixing DAC cells to reduce linear gradient mismatches for a mixing DAC, according to an aspect of the present invention;

FIG. 11 is a layout diagram for arranging in-phase and quadrature mixing DAC cells to reduce quadratic gradient mismatches for a mixing DAC, according to another aspect of the present invention;

FIG. 12 is a layout diagram for arranging in-phase and quadrature mixing DAC cells of a complex 5-bit mixing DAC, according to an embodiment of the present invention;

FIG. 13 is an electrical schematic diagram of a relevant portion of a mixing DAC that implements a cascade transconductance stage between a switching section of the mixing DAC and an RF transconductance section of the mixing DAC, according to an embodiment of the present disclosure; and

FIG. 14 is an electrical schematic diagram of a relevant portion of a mixing DAC that implements a cascode transconductance stage between a switching section of the mixing DAC and an RF transconductance section of the mixing DAC, according to yet another embodiment of the present invention.

The use of the same reference symbols in different drawings indicates similar or identical items.

### DETAILED DESCRIPTION

According to various aspects of the present invention, a number of techniques may be employed in the design of a radio frequency (RF) receiver to enhance image and harmonic rejection. For example, to improve harmonic rejection performance of an RF receiver that implements a mixing digital-to-analog converter (DAC), bits (associated with a thermometer encoded section of the mixing DAC) provided by a direct digital frequency synthesizer (DDFS) may be scrambled at certain frequencies to compensate for layout gradient mismatch of the mixing DAC. To minimize a noise penalty associated with switching of the mixing DAC, a switching reduction technique may also be employed to reduce switching of the mixing DAC. The receiver may also implement a single DDFS clock buffer with a balanced clock H-tree to uniformly distribute a clock signal and, thus, improve image rejection (i.e., in-phase/quadrature (I/Q) data arrival matching) and harmonic rejection (i.e., data arrival matching of different bits associated with an I or Q signal).

To improve image rejection of a mixing DAC, a layout of in-phase (I) cells and quadrature (Q) cells of the mixing DAC may be scrambled to cancel I/Q gradient mismatches. To improve harmonic rejection, another layout scrambling technique may also be employed in the design of the mixing DAC to cancel DAC distortion due to linear and quadratic mismatch. A cascode transconductance stage may also be implemented, following an RF transconductance section of a mixing DAC, to improve mixer linearity at high frequencies. As used herein, a “radio frequency” signal means an electrical signal conveying useful information and having a frequency from about 3 kilohertz (kHz) to thousands of gigahertz (GHz), regardless of the medium through which such signal is conveyed. Thus, an RF signal may be transmitted through air, free space, coaxial cable, fiber optic cable, etc. As used herein, the term “coupled” includes both a direct electrical connection between elements and an indirect electrical connection provided by intervening elements.

In general, a DDFS provides a binary number that represents a digital value of a local oscillator (LO) sampled sinusoidal waveform. The bits, which are provided to inputs of a mixing DAC, control associated switching sections (switching pairs) of the mixing DAC. The DAC of the mixing DAC may take various forms, e.g., a full binary encoded DAC, a full thermometer encoded DAC, or a segmented DAC having a thermometer encoded section and a binary encoded section. In the typical case, implementing a full binary encoded DAC within a mixing DAC architecture provides a mixing DAC having modest differential non-linearity (DNL) performance which may lead to relatively high amplitude LO harmonics that may degrade a harmonic rejection performance of an associated RF receiver. However, binary encoded DACs include a minimum number of data lines, buffers, synchronization latches, and switching pairs. For example, an N-bit full binary encoded DAC has N cells. As such, binary encoded DACs have relatively low power dissipation.

In contrast, a mixing DAC that has a full thermometer encoded DAC requires 2^{N}-1 cells, where N is the number of bits provided by the DDFS. In the usual case, a full thermometer encoded DAC provides better linearity, better integrated non-linearity (INL) and DNL, as compared to a full binary encoded DAC. As such, a full thermometer encoded DAC usually has better local oscillator (LO) harmonic rejection than a frill binary encoded DAC. Un-fortunately, full thermometer encoded DACs have a relatively large power dissipation and occupy a relatively large die area, as compared to full binary encoded DACs.

A compromise between power and area and linearity performance may be achieved by using a segmented mixing DAC in which a number of most significant bits (MSBs) are thermometer encoded, while remaining least significant bits (LSBs) are binary encoded. In general, the cells of a mixing DAC need to be matched to provide good mixing DAC linearity and image rejection. In general, better matching may be achieved by using a larger area. However, utilizing larger area cells results in higher parasitic capacitance and, thus, limits a maximum operating frequency of the mixing DAC. Typically, mixing DAC cells have a random component that is strictly dependent on device size and a deterministic component given by the physical gradients in the actual integrated circuit (IC). According to various aspects of the present invention, the gradients can be compensated by dynamically changing the physical cells that are used for a given DDFS data output. Rotating the cells that are used for a bit eliminates the gradient mismatch since each bit eventually uses all of the cells included within the mixing DAC over a period of time. Unfortunately, a main drawback of the scrambling process is the large number of switching events, which contribute to higher noise levels. In this case, the noise from the switching pairs may dominate the overall noise performance of the receiver.

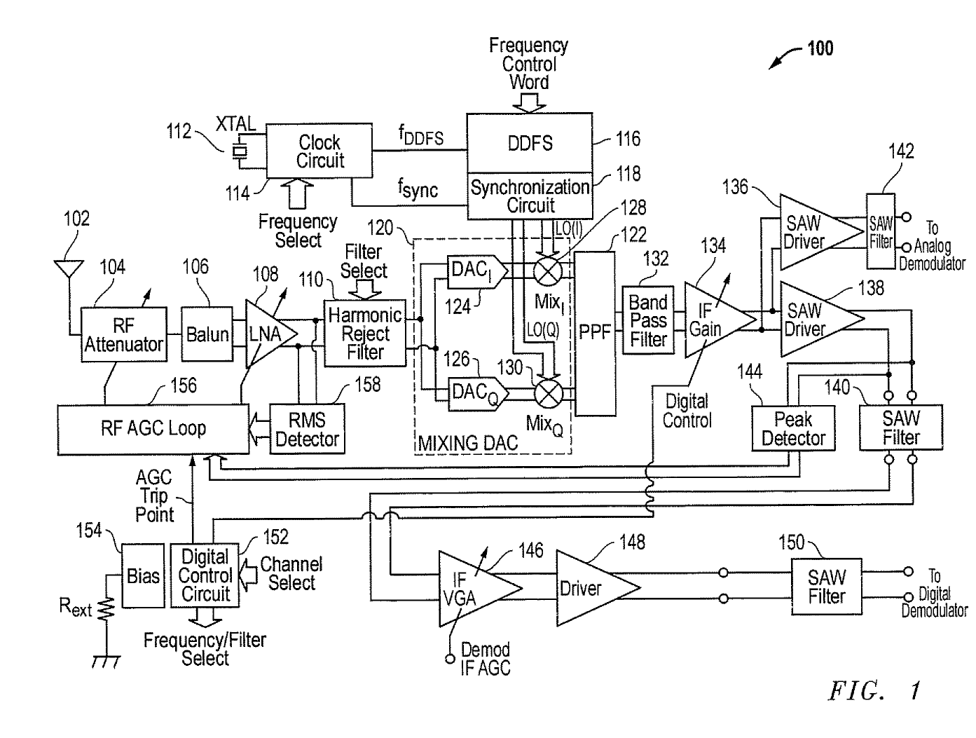

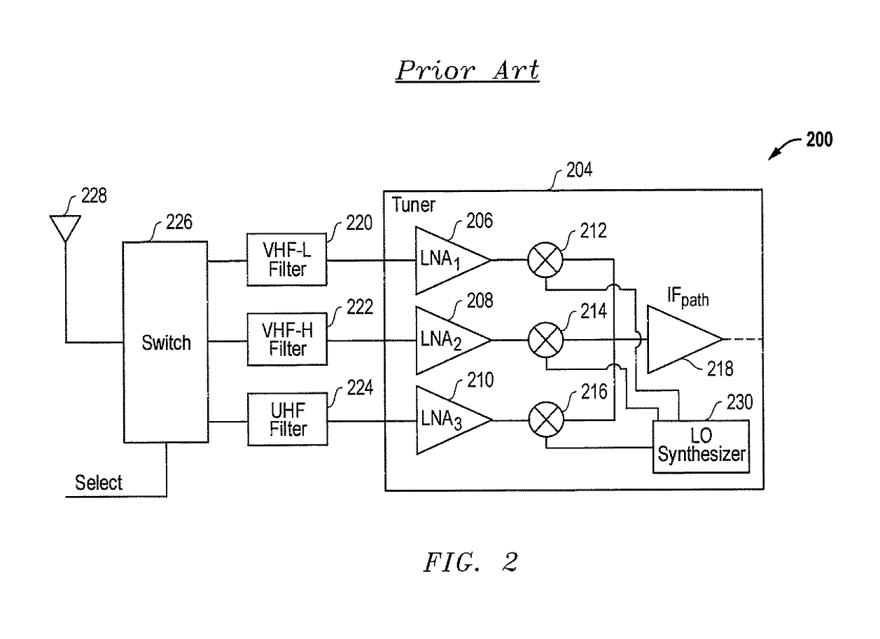

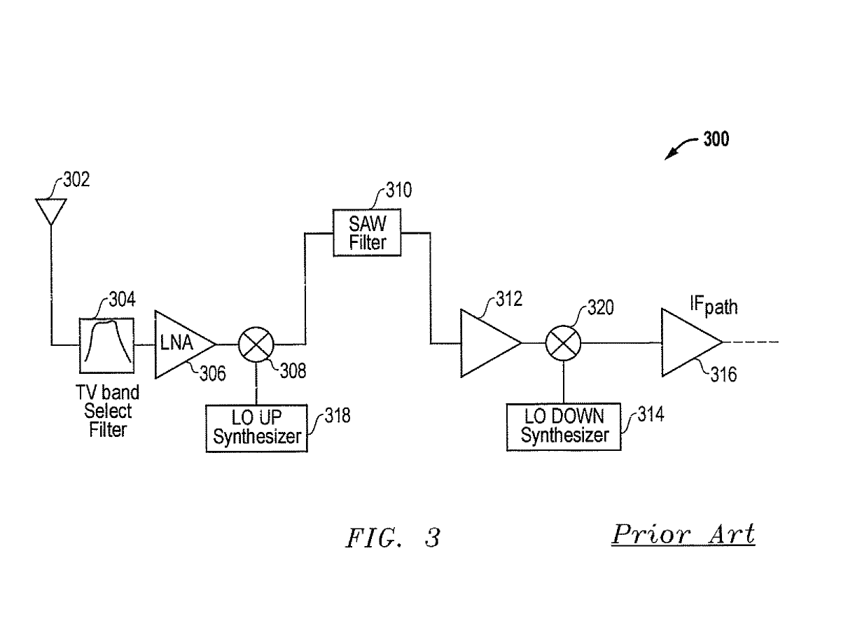

With reference to FIG. 1, an exemplary hybrid terrestrial/cable analog/digital television (TV) receiver (tuner) 100 is illustrated. The receiver 100 implements a direct digital frequency synthesizer (DDFS) 116 that drives a mixing digital-to-analog converter (DAC) 120, via a synchronization circuit 118, with a digital local oscillator (LO) signal. The synchronization circuit 118, which may include a master-slave latch structure and buffers, ensures that bits associated with quadrature LO signals (i.e., LO(I) and LO(Q)) arrive at respective inputs of the mixing DAC 120 at substantially similar arrival times. A clock circuit 114, which includes a phase locked loop (PLL), provides a DDFS clock signal (f_{DDFS}) to the DDFS 116 and a synchronization clock signal (f_{sync}) to the synchronization circuit 118. As is depicted, the receiver 100 includes an RF attenuator 104 that receives a TV signal from an antenna 102. An attenuation provided by the attenuator 104 is controlled by an RF automatic gain control (AGC) loop 156 such that strong incoming signals are adequately attenuated to avoid non-linearities (e.g., clipping) in an RF front-end, which includes low noise amplifier (LNA) 108 and the mixing DAC 120, etc. In general, the attenuator 104 should have a relatively low insertion loss such that it does not significantly impact noise figure performance of the receiver 100. The RF attenuator 104 may be implemented using, for example, an off-clip pin diode.

An output of the RF attenuator 104 is coupled to an input of a balun 106, which converts a signal at the output of the RF attenuator 104 into a differential signal, which is provided to a differential input of the LNA 108. In general, the balun 106 should have a relatively low insertion loss and a relatively good output amplitude and phase matching in order to minimize common mode to differential coupled noise/spur conversion at the input of the receiver 100. A 1 to N, e.g., a 1 to 2, balun can be used to provide gain in the signal path and, thus, reduce a noise contribution of active circuits in the receiver 100. Wile a balun can not provide power gain, i.e., it is a passive circuit, a balun can provide an impedance value change, e.g., from 75 Ohms to 300 Ohms in a 1 to 2 balun. By changing the reference impedance level, the noise figure of the receiver 100 may be improved.

The LNA 108 may be configured to have a programmable gain in discrete steps that is set by the RF AGC loop 156. In general, the LNA 108 should be designed to ensure good matching to the balun 106 output impedance. Outputs of the LNA 108 are respectively coupled to inputs of a programmable harmonic reject filter 110, which is configured to improve harmonic rejection performance of the receiver 100. At lower channel frequencies, e.g., in the VHF band, a low-pass filter may be employed to increase the blocker rejection of the LO harmonic frequencies, e.g., 2LO, 3LO, 4LO, etc. At higher channel frequencies, e.g., in the UHF band, a high-pass filter may be employed to reject harmonic distortion components generated by the LNA 108. When no harmonic issues exist, the filter 110 may be switched to an all-pass filter, such that the filter 110 does not degrade the noise figure performance of the receiver 100. It should be appreciated that the filter 110 may be realized as either a passive or an active filter. In general, passive filters have lower noise, but also exhibit lower harmonic rejection. In contrast, active filters provide a higher harmonic rejection, but generally exhibit larger noise contribution.

Outputs of the filter 110 are coupled to respective inputs of a mixing DAC 120, which in this case includes a pair of quadrature mixing DACs. The mixing DACs each have two main sub-blocks, i.e., RF transconductance sections 124 and 126 and switching sections (mixers) 128 and 130. The RF transconductance sections may be configured as, for example, RF transconductance DACs. The RF transconductance sections 124 and 126 convert an RF input voltage into an RF current, based on a value of each local oscillator (LO) bit provided by the DDFS 116. In general, a segmented DAC architecture offers a good power/performance compromise. Alternatively, a full binary encoded DAC or a full thermometer encoded DAC may be utilized. Typically, a full binary encoded DAC consumes lower power, but also exhibits lower linearity. In contrast, a full thermometer encoded DAC usually has higher linearity, but also requires higher power. In a typical application, the mixers 128 and 130 are configured as an array of switching pairs (Gilbert cells) that perform the mixing operation on a bit-by-bit basis. The mixer LO path includes a digital bus that provides a digital encoding, e.g., binary, thermometer, or segmented, of an instantaneous LO sampled sine wave to inputs of the mixers 128 and 130.

In general, the harmonic rejection of a mixing DAC depends both on the linearity of the RE transconductance section and on synchronization of DDFS control bit arrival times at the LO inputs of the mixers. As mentioned above, the outputs of the DDFS 116 are provided to inputs of the synchronization block 118. The DDFS 116 is driven by a first clock signal and the synchronization block 118 is driven by a second clock signal. The first and second clock signals may or may not have the same frequency, depending on whether the DDFS 116 is built as a single core or includes multiple cores. In general, the DDFS clock signal (f_{DDFS}) is less important in terms of phase noise and spurs since the LO data is synchronized later in the LO path. However, the second clock signal (f_{sync}) usually should have relatively low phase noise and low spurs, as the second clock signal determines the receiver phase noise and may impact the blocking performance of the receiver 100. The outputs of the mixers (MIX_{I} and MIX_{Q}) 128 and 130 are provided to a poly-phase filter (PPF) 122, e.g., a fifth-order PPF, that ensures a relatively high value image rejection level over a relatively wide intermediate frequency (IF) range that covers, for example, multiple TV standards, e.g., 33 MHz to 60 MHZ for Europe, USA, and Asian compliant TV receivers. The PPF 122 also performs complex-to-real conversion of the IF signal.

Outputs of the PPF 122 are coupled to respective inputs of bandpass filter 132. The bandpass filter 132 is implemented in the IF path in order to improve blocking performance of the receiver 100 and to lessen (or avoid) detection of blocker power by peak detector 144. The bandpass filter 132 may be implemented using a tuned active stage having an on-chip capacitance and an off-chip inductance that may be selected based on the TV standard. Outputs of the bandpass filter 132 are coupled to respective inputs of a programmable gain amplifier (PGA) 134 that sets the receiver 100 gain at a desired value based on the application, e.g., cable or terrestrial TV. As is depicted, an analog receiver path includes a surface acoustic wave (SAW) driver 136 that drives an off-clip SAW filter 142, whose output is coupled to an analog demodulator (not shown). An amplitude of a signal at the output of the driver 136 should generally be at least about 3 mV to ensure proper operation of an IF AGC loop. A digital receiver path includes a SAW driver 138 that drives an off-chip SAW filter 140, whose output is coupled to an input of an IF variable gain amplifier (VGA) 146. An output of the VGA 146 is coupled to an input of driver 148, whose output is coupled to an input of an off-chip SAW filter 150, whose output is coupled to an input of a digital demodulator (not shown). To reduce the cost of the receiver 100, the SAW filter 150 may be omitted and in this case, the driver 148 would directly drive the digital demodulator.

In a typical analog/digital RF receiver, a digital demodulator does not include a built-in IF AGC loop. Thus, for digital TV applications, an additional 50 to 65 decibel (dB) gain is usually required, depending on SAW filter insertion loss, to provide a desired amplitude at an analog-to-digital converter (ADC) input of the digital demodulator. In this embodiment, the VGA 146 is employed to provide a desired gain and gain range. To avoid clipping of the signals at the RF front-end and at an output of IF path SAW driver 138, a dual RF/IF AGC loop may be implemented. In this case, a gain of both the RF attenuator 104 and the LNA 108 are set by the AGC loop 156, based on a power level sensed by an RF root mean square (RMS) detector 158 and peak signal level sensed by the peak detector 144 (at the SAW driver 138 output). A variable AGC trip point can be set via a digital control interface circuit 152, which also sets the gain in the IF path and control parameters for the clock circuit 114 and the DDFS 116. A bias circuit 154 may be employed that utilizes a high precision external resistor (Rₑₓₜ) to accurately set bias current and voltage levels required for proper operation of the receiver 100.

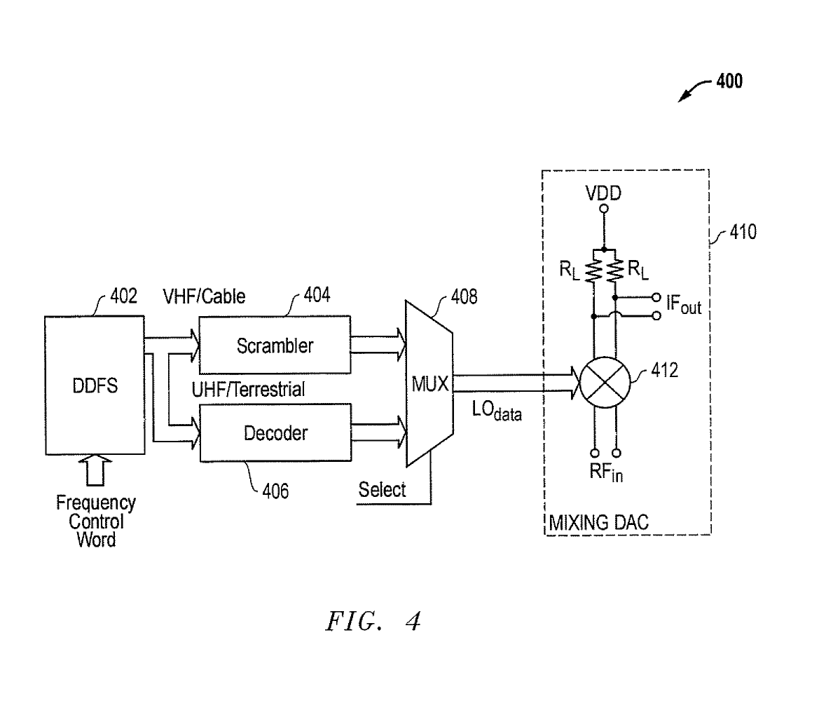

With reference to FIG. 4, a relevant portion of an RF receiver 400 is shown that employs a hybrid scrambled/non-scrambled mixing DAC architecture. The receiver 400 includes a direct digital frequency synthesizer (DDFS) 402 that provides a local oscillator (LO) signal, in the form of data bits, for driving a switching section (mixer) 412 of a mixing digital-to-analog converter (DAC) 410. Bits, e.g., MSBs, of the LO signal are provided by the DDFS 402 to inputs of a scrambler 404 and a decoder 406. The bits are used to drive switching pairs associated with a thermometer encoded DAC or a thermometer encoded DAC section of a segmented DAC (i.e., a DAC that includes a thermometer encoded DAC section and a binary encoded DAC section). Outputs of the scrambler 404 are coupled to first inputs of a multiplexer 408 and outputs of the decoder 406 are coupled to second inputs of the multiplexer 408. A select signal, which may be based on a band in which a desired channel resides or whether the receiver 400 is operating as a terrestrial or cable TV receiver, determines whether the scrambler 404 or the decoder 406 provides the bits of the LO signal. As is shown, outputs of the multiplexer 408 provide the bits associated with the LO signal to respective inputs of the mixer 412.

In general, the architecture depicted in FIG. 4 may be employed to reduce the noise penalty attributable to excessive switching of the switching pairs of a mixing DAC. In most receivers, the noise figure at low frequencies (e.g., VHF band between about 40 MHz to 400 MHz) is significantly lower than the noise figure at high frequencies (e.g., UHF band between about 400 MHz to 1 GHz). Typically, the 2LO and 3LO harmonic rejection issues are present only for the low frequency channels (e.g., the VHF band). In a typical case, all harmonic blockers for the UHF band are out-of-band (i.e., out of the TV band). Usually, implementing a hybrid mixing DAC that uses scrambled LO data for VHF channels and non-scrambled LO data for UHF channels provides an RF receiver having better noise/harmonic rejection performance.

Typically, a terrestrial TV receiver requires a very low noise figure (NF) of approximately 5 to 7 decibel (dB) and has fewer harmonic rejection issues, due to the sparse nature of the terrestrial TV spectrum. In contrast, cable TV receivers usually have a relaxed noise figure requirement of about 8 to 10 dB, but have more stringent harmonic rejection requirements due to the fully populated nature of the cable TV spectrum. In general, a hybrid scrambled/non-scrambled mixing DAC architecture may be employed to provide a better overall performance for hybrid terrestrial/cable TV receivers. That is, for cable reception scrambling may be used to improve harmonic rejection and for terrestrial reception a non-scrambled mode may be used to optimize a noise figure of the receiver at lower frequencies.

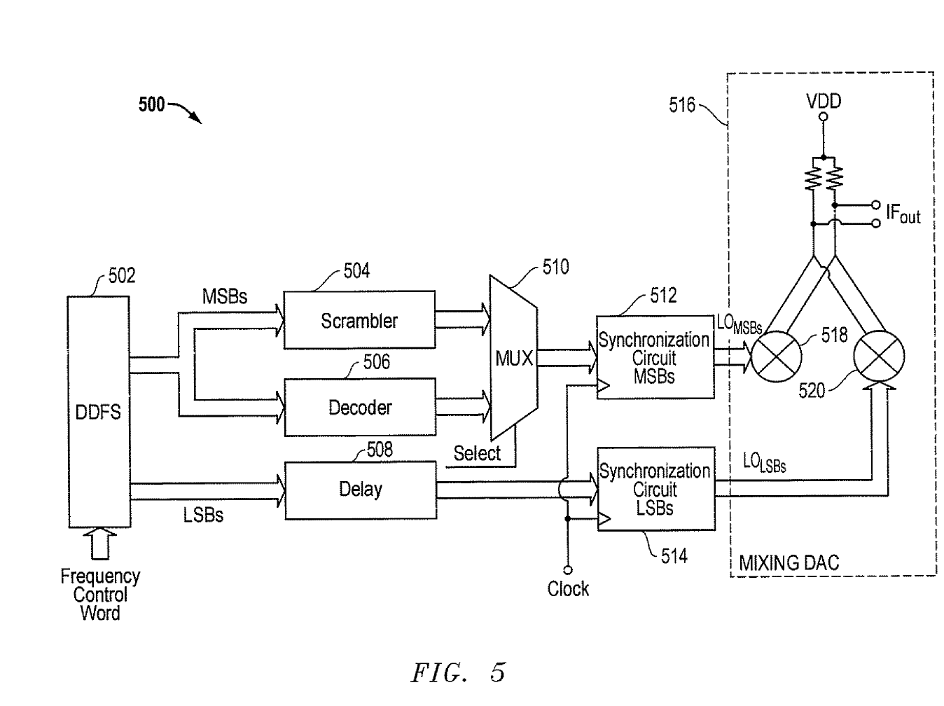

With reference to FIG. 5, an RF receiver 500 is depicted that implements a mixing DAC 516 architecture that employs a segmented DAC in which most significant bits (MSBs) are thermometer encoded (with or without scrambling) and least significant bits (LSBs) are binary encoded. In a typical embodiment all bits are synchronized by a single clock signal, which drives an MSB synchronization circuit 512 and an LSB synchronization circuit 514, to ensure that switching pairs of mixing DAC 516 are switching at the same time. As is shown, the receiver 500 includes a direct digital frequency synthesizer (DDFS) 502 that provides a local oscillator (LO) signal that includes a first number of MSBs and a second number of LSBs. The MSBs are provided to inputs of a scrambler 504 and a decoder 506, whose outputs are coupled to first and second inputs, respectively, of a multiplexer 510.

A select signal is provided on a select line of the multiplexer 510 to control whether the scrambler 504 or the decoder 506 is selected to provide the MSBs of the LO signal to inputs of MSB synchronization circuit 512. For example, when harmonic issues are more problematic than noise issues, the select signal selects the scrambler 504 to provide the MSBs. On the other hand, when noise issues are more problematic than harmonic issues, the select signal selects the decoder 506 to provide the MSBs. A delay block 508 delays the LSBs such that the LSBs have substantially the same arrival time at inputs of the LSB synchronization circuit 514 as the MSBs at the inputs of the MSB synchronization circuit 512. Outputs of the circuit 512 are coupled to inputs of switching pairs (mixer) 518 and outputs of the circuit 514 are coupled to inputs of switching pairs (mixer) 520.

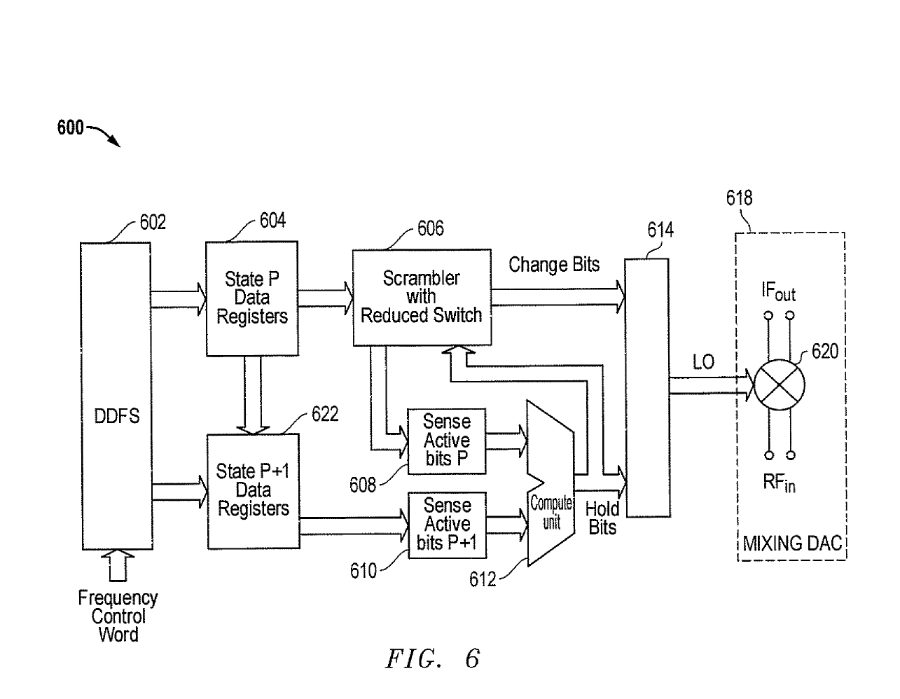

Another technique to improve harmonic rejection of a mixing DAC, while maintaining a relatively low noise figure, is to reduce the amount of switching in the switching pairs (mixer) of the mixing DAC. In general, the gradient mismatch of the switching pairs (cells) is a static phenomena and does not require fast switching of the cells or switching at every local oscillator (LO) sampling frequency cycle. With reference to FIG. 6, a relevant portion of an RF receiver 600 that employs a mixing DAC architecture that implements reduced switching of switching pairs (I/Q cells) is illustrated. The receiver 600 includes a direct digital frequency synthesizer (DDFS) 602, whose outputs are coupled to a pair of data registers 604 and 622. Outputs of the data register 604 are coupled to inputs of a scrambler 606 and outputs of the data register 622 are coupled to inputs of detector 610. First outputs of the scrambler 606 are coupled to inputs of detector 608.

Outputs of the detectors 608 and 610 are coupled to respective inputs of compute unit 612. Outputs of the compute unit 612 are coupled to second inputs of scrambler 606 and first inputs (hold bits) of logic 614. Second outputs (change bits) of the scrambler 606 are coupled to second inputs of the logic 614. The data register 604 stores LO data for a state ‘P’ and the data register 622 stores LO data for a next state ‘P+1’. To reduce the amount of switching during scrambling, the detector 608 senses the bits that are active in state ‘P’ and the detector 610 senses the bits that are active in state ‘P+1’. A compute unit 612 determines which of the bits that are active in state ‘P’ should be held active in state in ‘P+1’ and which bits to change from state ‘P’ to state ‘P+1’. The logic 614 utilizes the change bits and the hold bits to determine which inputs of mixer 620 of mixing DAC 618 are active/inactive. Employing this technique, usually allows for reduction in the switching of the switching pairs by an order of magnitude while still providing relatively good randomization of the gradient mismatch.

It should be appreciated that the linearity of the mixing DAC and, thus, its harmonic rejection performance is dependant on synchronization of LO signal bits provided by a DDFS. In general, delay of the arrival time of the DDFS LO bits at the inputs of a mixing DAC has a periodic nature and generally results in either LO harmonics or spurs. Either the LO harmonics or the spurs can down convert undesired blocker signals on top of the desired signal and degrade a signal-to-noise ratio (SNR) of the desired signal. Employing a relatively large number of DDFS LO bits usually requires a balanced clock distribution network to provide equal propagation times for all bits.

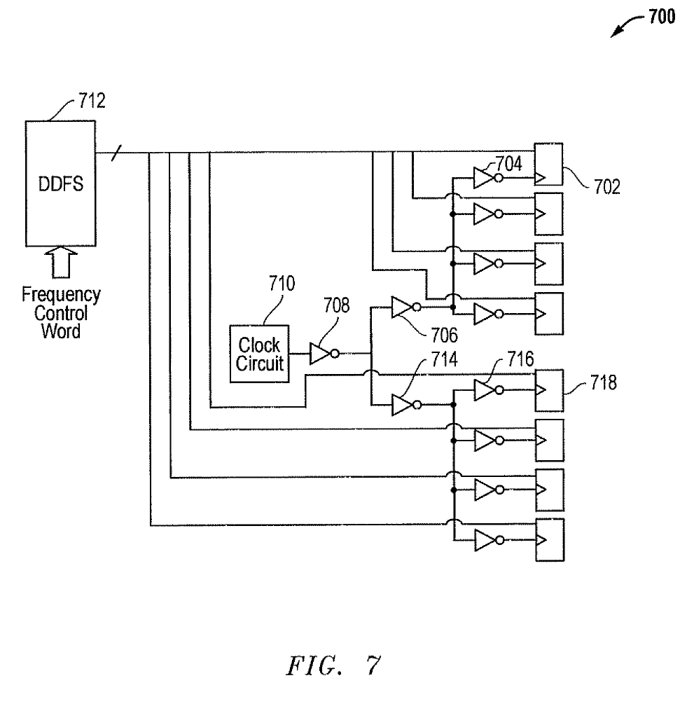

Moving to FIG. 7, a relevant portion of an RF receiver 700 is depicted that illustrates an approach for clock synchronization of data bits provided by a direct digital frequency synthesizer (DDFS) 712. As is shown, outputs of the DDFS 712 are coupled to inputs of respective synchronization latches 702 and 718. A clock circuit 710, including a phase locked loop (PLL), provides a clock signal to an input of a buffer (an inverter) 708, whose output is coupled to an input of buffers (inverters) 706 and 714. An output of the buffer 706 is coupled to an input of respective buffers (inverters) 704, whose respective outputs are each coupled to a clock input of a respective one of the latches (e.g., latches for in-phase (I) signals) 702. An output of the buffer 714 is coupled to an input of respective buffers (inverters) 716, whose respective outputs are each coupled to a clock input of a respective one of the latches (e.g., latches for quadrature (Q) signals) 718. From a power efficiency standpoint, providing a clock signal to each mixing DAC unit cell using a buffered clock tree provides a relatively good solution. The main drawback of this technique is that the mismatch between different clock buffers, although relatively small, may not result in providing a desired high image rejection and harmonic rejection, e.g., greater than 70 dB, at GHz frequencies.

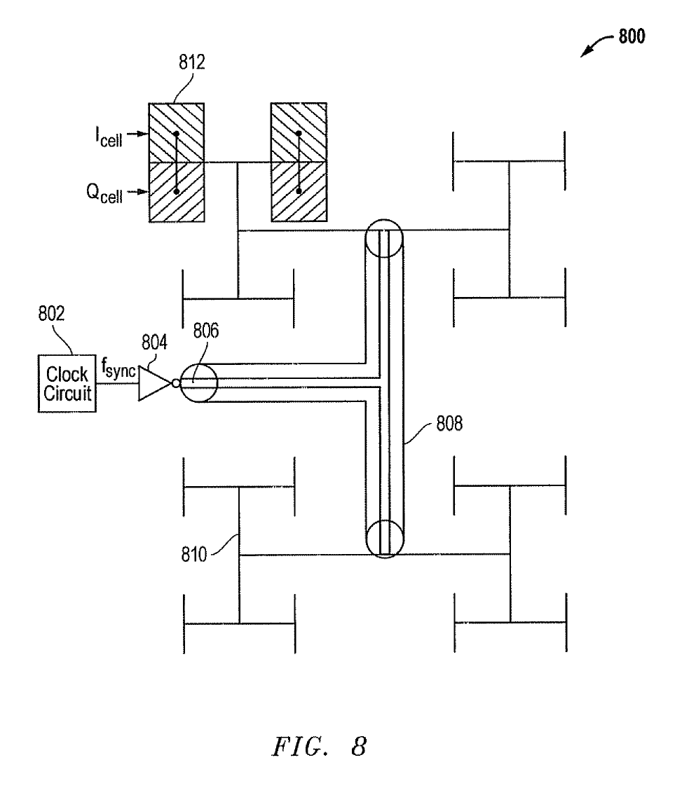

It should be appreciated that mismatches between the clock path delay of different bits within a mixing DAC degrades the harmonic rejection of the receiver. Moreover mismatches between the in-phase (I) and quadrature (Q) clock signals in a complex mixer results in poor image rejection. As such, it is generally not desirable to use separate I and Q clock buffers (as is shown in FIG. 7) in receivers that require high image rejection, as matching at a 70 db level (or higher) requires relatively large area devices that unfortunately have relatively high parasitic capacitance and, as such, typically cannot operate at multi-GHz frequencies. To address this concern, a layout 800 that employs a single clock buffer (inverter) 804, as is shown in FIG. 8, may be implemented for all I and Q data bits. As is depicted, a clock circuit 802, including a phase locked loop (PLL), is coupled to an input of the buffer 804, whose output is coupled to an input of a clock H-tree 806. In general, matching of the length of all the clock paths to individual mixer unit cells may be achieved by implementing a uniform square-like layout with a weighted width balanced H-tree signal line being employed to route a clock signal to the individual mixer cells. It should be appreciated that reducing power in a local oscillator path generally requires a minimization of a parasitic capacitance presented by the clock H-tree. To achieve relatively good balance, a metal width of the clock H-tree may be cut in half at each clock H-tree branch.

Depending upon the application, the clock H-tree 806 may be placed inside a metal shield 808 to avoid parasitic couplings to the clock H-tree 806 that may exhibit an asymmetric nature. For an N bit complex mixing DAC that uses M thermometer encoded bits the number of lines are 2*2*((2^{M}−1)+(N−M)) RF input current lines and 2*((2^{M}−1)+(N−M)) DDFS LO data lines. In general, it is desirable for a clock tree to employ a balanced H-tree structure to ensure good synchronization between data bit arrival. Moreover, it is desirable for the IF output current to use a balanced H-tree structure as any mismatch in the propagation delay in the IF path can significantly degrade harmonic rejection of a mixing DAC. Usually the DDFS LO data path is not that critical since the bits are resynchronized by a synchronization circuit. As such, depending upon the application, a linear or matched length routing technique may be utilized. Depending upon the application, the RF current path may carry GHz signals and, in this case, a relatively large parasitic capacitance should be avoided. As such, in this application, matched length routing of the RF current path may be employed to reduce parasitic capacitance.

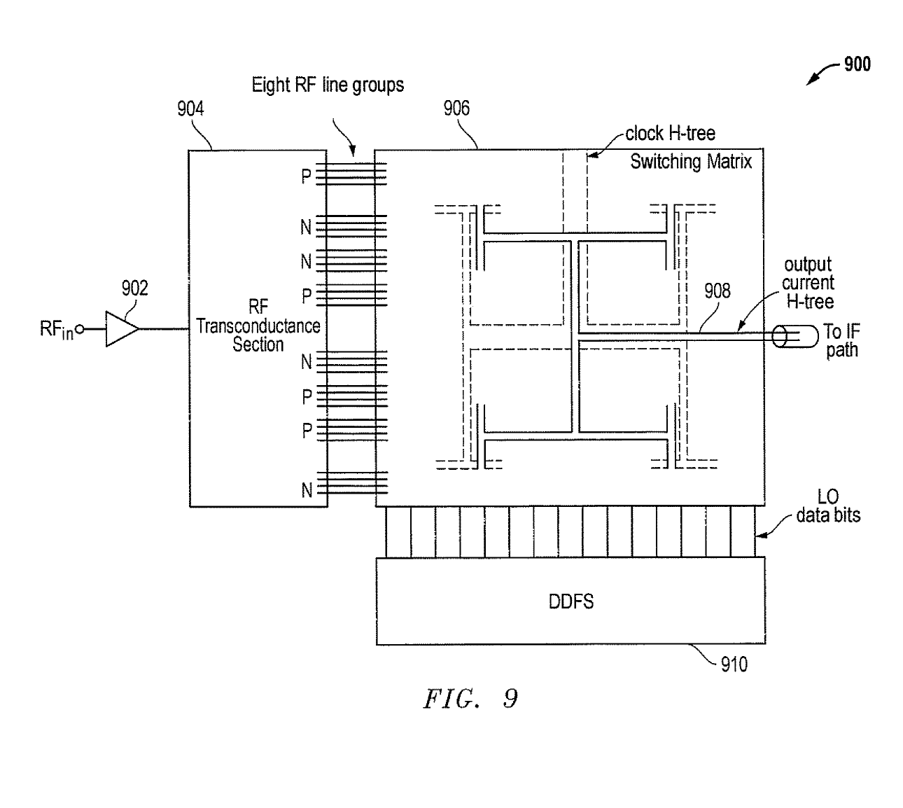

In general, a mixing DAC should have a relatively compact layout in order to avoid large gradient mismatches. Unfortunately, compact layouts tend to have large parasitic capacitance between different metal lines. To address this issue, boot strapping of the parasitic capacitance may be employed. With reference to FIG. 9, a mixing DAC 900 includes positive (P) and negative (N) signal path lines that couple portions of an RF transconductance section 904, which receives an RF input signal via a low noise amplifier (LNA) 902, to a switching matrix 906. A DDFS 910 provides a LO signal to switching pairs of the switching matrix 906. While only sixteen lines are shown coupling the DDFS 910 to the switching matrix 906, it should be appreciated that more or less than sixteen lines may be implemented between a DDFS and switching pair inputs of a mixing DAC. As is shown, the P and N signal path lines are grouped and routed together with relatively large spacing employed between the P and N groups. In general, uniform spacing of the lines provides minimum capacitance between the lines. Typically, the most critical parameter is the parasitic capacitance between the N and P lines and from each N and P line to ground. While grouping the P and N lines in close proximity increases the parasitic capacitance between the lines of the groups, as the signal lines in the groups have the same signal level the parasitic capacitance is neutralized. As a result, the adverse effect of the parasitic capacitance associated with the P and N lines is reduced. The mixing DAC 900 also employs a balanced H-tree 906 in the IF path, i.e., between a load and switching pairs, to reduce mismatch in the IF path. In general, mismatch in the IF path can cause propagation delay between currents provided by different cells of a mixing DAC and can significantly degrade harmonic rejection performance of the mixing DAC.

In circuits that occupy relatively large areas, a significant contribution to the mismatch is attributable to spatial gradient. In this case, a common centroid layout may be employed to cancel the first-order gradient. However, in integrated circuit (IC) processing, due to wafer spinning during processing, a second-order, or higher-order gradient may also require consideration. In deep submicron (e.g., less than 0.13 microns) complementary metal-oxide semiconductor (CMOS) processes, the gradient mismatch is an important component of device-to-device mismatch. This is particularly true in relatively large area circuits, such as mixing DACs, that usually need to achieve a native (without calibration or correction) 65 to 75 dB image rejection. In general, the most important gradients are the linear and quadratic gradients. As previously noted, implementing DDFS LO data scrambling may compensate for gradient mismatch by randomizing harmonic DAC distortion (i.e., 2LO, 3LO, etc.) into white noise. However, one drawback of scrambling is that scrambling may result in increased noise due to switching of switching pairs. A scrambled layout approach may be employed to reduce harmonic issues without also increasing noise, as is the case with LO data bit scrambling.

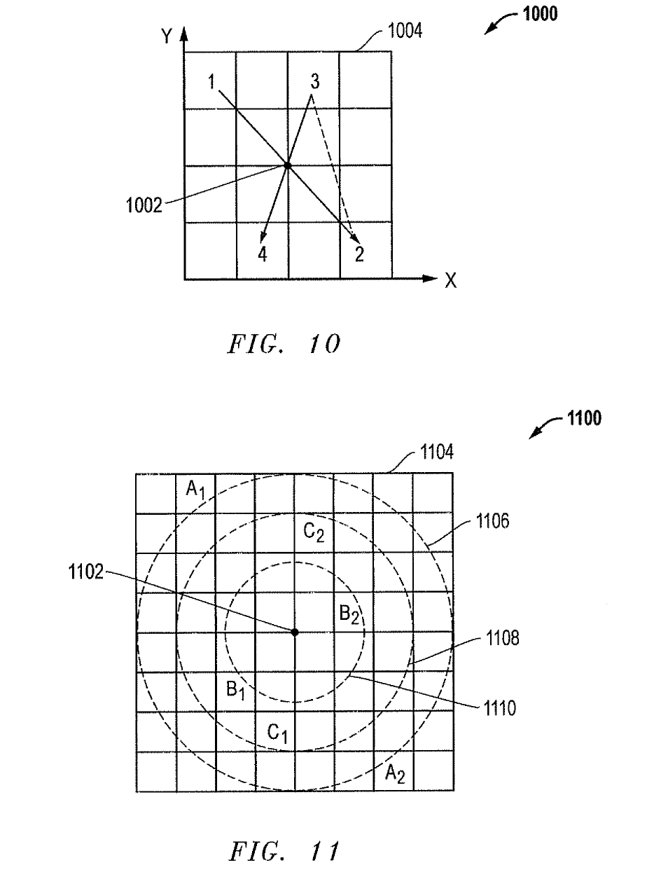

With reference to FIG. 10 a mixing DAC switching matrix cell layout diagram 1000 depicts a technique that can be implemented to cancel linear gradients on a horizontal and vertical axes. In general, any arbitrary linear gradient can be de-composed into two linear gradients on horizontal and vertical axes. In general, the approach is based on the fact that two cells 1004 situated at symmetric positions with respect to a layout symmetry center 1002 have substantial equal value and opposite sign mismatches. As such, the gradient may be reduced by selecting bits in consecutive pairs that use cells that are at symmetric positions (e.g., cell 1 and cell 2) versus the symmetry center 1002. To prevent accumulation of linear gradient in one or more directions, substantially orthogonal consecutive pairs (e.g., cell 1-cell 2 and cell 3-cell 4) may be selected. This technique substantially cancels the linear gradient in both the ‘X’ and ‘Y’ directions. However, it should be appreciated that a quadratic gradient may still exist, as, during IC processing, wafers are spinned which results in a strong quadratic gradient component.

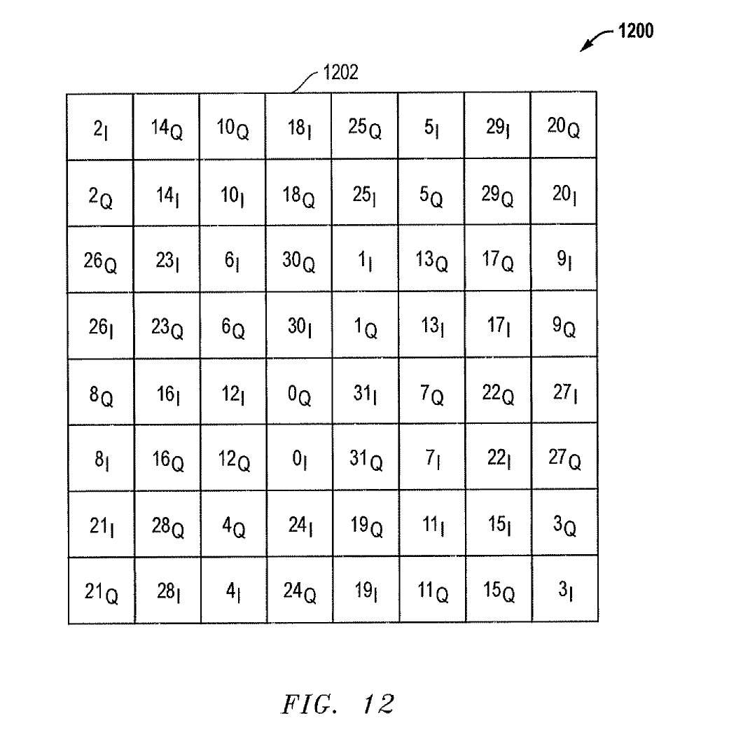

Turning to FIG. 11 a mixing DAC switching matrix cell layout diagram 1100 depicts a layout for cells 1104 that addresses linear and quadratic gradients. In this embodiment, activated ones of the cells 1104 are situated on increasing diameter circles 1110, 1108, and 1106 from symmetry center 1102. By activating cells on concentric circles, a quadratic mismatch can be approximately cancelled by considering that a mismatch at cells A1 and A2 on the circle 1106 is approximately equal to the sum of mismatches attributable to cells B1 and B2 on inner circle 1108 and cells C1 and C2 on inner circle 1110. In this embodiment, after one A type cell is switched a B type cell is switched followed by a C type switch. In this manner, the quadratic gradient mismatch may be generally reduced. The technique can be generalized to a larger number of cell types. By combining the above techniques, cells on orthogonal axes (e.g., cells A1-A2 and cells B1-B2/C1-C2) may be selected to substantially cancel both linear and quadratic gradients.

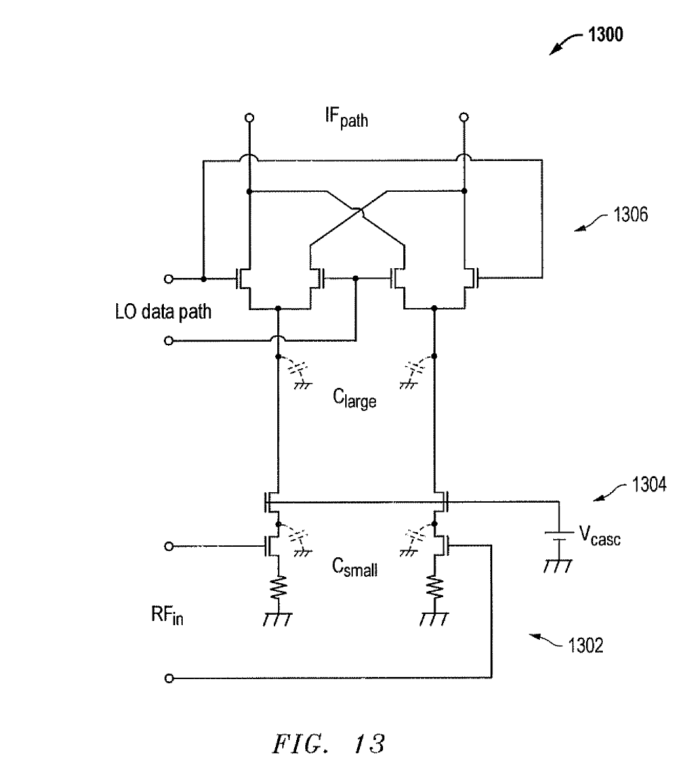

Turning to FIG. 12 a mixing DAC switching matrix cell layout diagram 1200 for a mixing DAC having five thermometer encoded bits is depicted. In the diagram 1200, in-phase (I) and quadrature (Q) cells 1202 are distributed to provide good image rejection ratio (IRR) and reduce up to third-order gradients. Using the linear and quadratic cancellation techniques in the layout of a mixing DAC improves harmonic rejection performance of the mixing DAC. It should be appreciated the techniques disclosed herein can be can be generalized to a mixing DAC having a higher or lower number of thermometer encoded bits.

Mixing DAC linearity and harmonic rejection of a mixing DAC also depend on an output impedance of an RF transconductance section of the mixing DAC at high frequencies. While an RF transconductance section may use resistive degeneration, an output impedance of the RF transconductance section is usually not high enough to achieve better than a −70 dB harmonic (2LO and 3LO) rejection. To address this issue, a cascode transconductance stage may be implemented between an RF transconductance section and a switching section in order to improve the output impedance of the RF transconductance section. At relatively high frequencies, the output impedance of the RF transconductance section is dominated by parasitic capacitance, which includes a device parasitic capacitance component and a layout parasitic capacitance component. In a relatively large area mixing DAC that needs to natively (i.e., with no collection or calibration) achieve an image rejection specification, the layout parasitic capacitance may dominate.

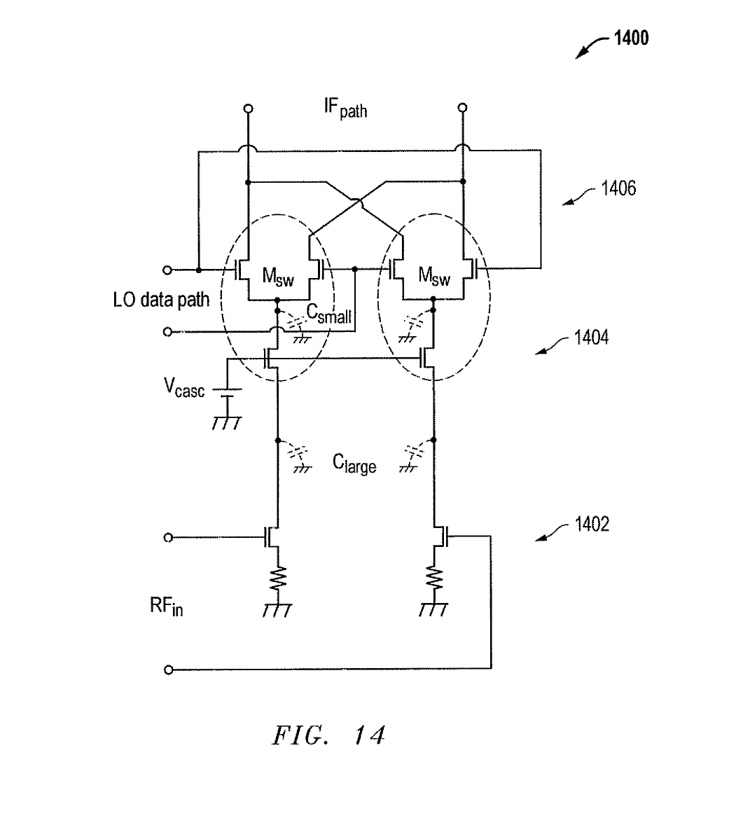

With reference to FIG. 13, a mixing DAC 1300 includes a cascode (transconductance section) device 1304 that is positioned adjacent an output of RF transconductance section 1302. This configuration provides a low value capacitance Cₛₘₐₗₗ at an output of the RF transconductance section 1302, which usually improves a bandwidth of the RF transconductance section 1302. However, in has configuration, a relatively large parasitic capacitance C_{large} is positioned at an input of switching section (mixer) 1306. As a result, the mixing DAC 1300 has relatively poor linearity and, thus, the mixing DAC 1300 exhibits a modest local oscillator harmonic rejection.

With reference to FIG. 14, a mixing DAC 1400 is depicted that implements a cascode (transconductance section) device 1404 adjacent an input of switching section (mixer) 1406. This configuration provides a relatively low value capacitance Cₛₘₐₗₗ at the input of the mixer 1406 and provides a relatively large parasitic capacitance C_{large} at an output of the RF transconductance section 1402. While placing a relatively large parasitic capacitance at the output of the RF transconductance section 1402 impacts image rejection at high frequency, the parasitic capacitance C_{large} does not significantly affect the harmonic rejection of the mixing DAC 1400. Moreover, the arrangement provides a relatively high output impedance at high frequency for the RF current provided by the RF transconductance stage 1402, which usually improves linearity of the mixing DAC 1400.

The above-disclosed subject matter is to be considered illustrative, and not restrictive, and the appended claims are intended to cover all such modifications, enhancements, and other embodiments that fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A receiver, comprising:
a mixing digital-to-analog converter (DAC) having a radio frequency (RF) input configured to receive an RF signal, control inputs configured to receive bits associated with a digital local oscillator (LO) signal and an output, wherein the mixing DAC is configured to mix the RF signal with the digital LO signal to provide an analog output signal at the output of the mixing DAC;
a direct digital frequency synthesizer (DDFS) having outputs configured to provide the bits associated with the digital LO signal;
a scrambler having inputs coupled to the outputs of the DDFS, wherein the scrambler is configured to scramble the bits of the digital LO signal;
a decoder having inputs coupled to the outputs of the DDFS, wherein the decoder is configured to provide the bits of the digital LO signal without scrambling; and
a multiplexer including first inputs coupled to outputs of the scrambler, second inputs coupled to outputs of the decoder, and outputs coupled to the control inputs of the mixing DAC, wherein the multiplexer is configured to couple the first inputs to the control inputs of the mixing DAC for a first frequency band and to couple the second inputs to the control inputs of the mixing DAC for a second frequency band.

2. The receiver of claim 1, wherein the first frequency band is more densely populated with channels than the second frequency band.

3. The receiver of claim 2, wherein the first frequency band corresponds to a cable television (TV) band and the second frequency band corresponds to a terrestrial TV band.

4. The receiver of claim 1, wherein the first frequency band is included within a very high frequency (VHF) band and the second frequency band is included within an ultra high frequency (UHF) band.

5. The receiver of claim 1, wherein the second frequency band is higher in frequency than the first frequency band and does not overlap with the first frequency band.

6. The receiver of claim 1, wherein harmonic issues dominate noise issues in the first frequency band and noise issues dominate harmonic issues in the second frequency band.

7. A receiver, comprising:
a mixing digital-to-analog converter (DAC) having a radio frequency (RF) input configured to receive an RF signal, control inputs configured to receive bits associated with a digital local oscillator (LO) signal and an output wherein the mixing DAC is configured to convert the RF signal to an RF current signal and mix the RF current signal with the digital LO signal to provide an analog output signal at the output of the mixing DAC;
a direct digital frequency synthesizer (DDFS) having outputs configured to provide the bits associated with the digital LO signal and having a first clock input configured to receive a first clock signal that sets a sample rate for the digital LO signal; and
a synchronization circuit coupled between the outputs of the DDFS and the control inputs of the mixing DAC, wherein the synchronization circuit includes a clock H-tree for distributing a clock signal to latches of the synchronization circuit.

8. The receiver of claim 7, wherein the output of the mixing DAC is configured as an output H-tree.

9. The receiver of claim 7, further comprising:
a shield positioned to reduce parasitic coupling for at least a portion of the clock H-tree.

10. The receiver of claim 7, wherein a metal width of the clock H-tree is cut in half at each branch.

11. The receiver of claim 7, wherein the mixing DAC further comprises:
a radio frequency (RF) transconductance section configured to provide the RF input;
a switching section configured to provide the control inputs and the output; and
a cascode transconductance section coupled between the RF transconductance section and the switching section, wherein the cascode transconductance section is positioned to minimize input capacitance of the switching section.

12. A receiver, comprising:
a complex mixing digital-to-analog converter (DAC), comprising:
an in-phase radio frequency (RF) transconductance section having an input configured to receive an RF signal and an output configured to provide an in-phase RE current signal;
a quadrature RF transconductance section having an input configured to receive the RF signal and an output configured to provide a quadrature RF current signal;
a switching matrix including in-phase (I) cells and quadrature (Q) cells, wherein the I cells are coupled to the in-phase RF transconductance section and the Q cells are coupled to the quadrature REF transconductance section and each of the I and Q cells includes a synchronization circuit having an input configured to receive a bit associated with either an in-phase digital local oscillator (LO) or a quadrature digital LO signal and a switching section having a control input coupled to an output of the synchronization circuit, and wherein the synchronization circuit in each of the I and Q cells is configured to be clocked by a common clock signal to synchronize the bits associated with the in-phase and quadrature digital LO signals at the control input of the switching section in each of the I and Q cells; and
a direct digital frequency synthesizer (DDFS) having outputs configured to provide the bits associated with the in-phase and quadrature digital LO signals, wherein the I and Q cells are arranged to substantially cancel linear gradients along horizontal and vertical axes of the switching matrix when the receiver is operational.

13. The receiver of claim 11, wherein the I and Q cells are also arranged to substantially cancel a quadratic gradient of the switching matrix when the receiver is operational.

14. The receiver of claim 11, wherein the I and Q cells are also arranged to substantially cancel third-order and lower-order gradients of the switching matrix when the receiver is operational.

15. A method of reducing switching noise associated with a thermometer encoded digital-to-analog converter (DAC) section of a mixing DAC, comprising:
receiving a radio frequency (RF) signal at an input of an RF transconductance section of a mixing DAC, the RF transconductance section converting the RF signal into an RF current signal; and
mixing the RF current signal with a digital local oscillator (LO) signal using a switching matrix that is coupled to the RF transconductance section, wherein the switching matrix is divided into multiple cells each of which includes a synchronization circuit having an input configured to receive a bit of the digital LO signal and a switching section having a control input coupled to an output of the synchronization circuit, and wherein the synchronization circuit in each of the multiple cells is configured to be clocked by a common clock signal to synchronize the multiple bits associated with the digital LO signal at the control input of the switching section in each of the multiple cells.

16. The method of claim 15, wherein the mixing further comprises:
selecting, based on a center of the switching matrix, a first symmetrically positioned pair of the multiple cells for activation; and
activating the first symmetrically positioned pair of the multiple cells.

17. The method of claim 16, wherein the mixing further comprises:
selecting, based on the center of the switching matrix, a second symmetrically positioned pair of the multiple cells for activation following the activation of the first symmetrically positioned pair of the multiple cells, the first symmetrically positioned pair of the multiple cells being located on a first line and the second symmetrically positioned pair of the multiple cells being located on a second line that is substantially orthogonal to the first line; and
activating the second symmetrically positioned pair of the multiple cells.

18. The method of claim 16, wherein the mixing further comprises:
selecting, based on a center of the switching matrix, a second symmetrically positioned pair of the multiple cells for activation following the activation of the first symmetrically positioned pair of the multiple cells, the first symmetrically positioned pair of the multiple cells being located on a first line and the second symmetrically positioned pair of the multiple cells being located on a second line that is substantially orthogonal with respect to the first line, wherein the first symmetrically positioned pair of the multiple cells is positioned on a first circle having a first radius from the center of the switching matrix and the second symmetrically positioned pair of the multiple cells is positioned on a second circle having a second radius from the center of the switching matrix, and wherein the second radius is less than the first radius.

19. The method of claim 18, wherein the mixing further comprises:
selecting, based on the center of the switching matrix, a third symmetrically positioned pair of the multiple cells for activation following the activation of the second symmetrically positioned pair of the multiple cells, the third symmetrically positioned pair of the multiple cells being located on a third line that is substantially orthogonal to the first line, wherein the third symmetrically positioned pair of the multiple cells is positioned on a third circle having a third radius from the center of the switching matrix, and wherein the third radius is less than the second radius.

20. A method of reducing switching in a thermometer encoded digital-to-analog converter (DAC) that includes switching matrix cells, wherein the thermometer encoded DAC section is included within a mixing DAC of a receiver, the method comprising:
determining first active bits for a digital local oscillator (LO) signal in a current state, wherein the first active bits are each associated with respective first cells included within the switching matrix cells, and wherein the digital LO signal is provided to control inputs of the mixing DAC;
determining second active bits for the digital LO signal for a next state, wherein the second active bits are each associated with respective second cells included within the switching matrix cells; and
reducing noise induced switching in the mixing DAC by ensuring that at least one of the first cells is included within the second cells.
